(19) United States
(12) Patent Application Publication
(10) Pub. No.: US 2001/0019206 A1
(43) Pub. Date: Sep. 6, 2001

(54) Foldable photo display unit

(76) Inventor: Mary E. Deans, Longwood, FL (US)

Correspondence Address: Timothy H. Van Dyke, Bencen & Van Dyke, P.A., 1630 Hillcrest Street, Orlando, FL, 32803, US

(21) Appl. No.: 09/778,048

(22) Filed: Feb. 5, 2001

Related U.S. Application Data
(63) Continuation of application No. 09/032,012, filed on Jan. 26, 1998, now abandoned.

(51) Int. Cl. B42D 1/00

(52) U.S. Cl. 281/2; 281/5; 283/61; 283/62; 402/79

(57) ABSTRACT

Disclosed herein is a display unit for displaying photographs and other articles, wherein said display unit is collapsible to form a compact unit for convenient transport.

### SUMMARY OF THE INVENTION

The field of endeavor to which this invention pertains is easy and safe photo containment, display and transport. The subject invention pertains to a space saving photo display unit which allows several photos to be viewed and at the same time has the advantages of being easily placed, collapsed, folded up and transported. This invention solves several drawbacks possessed by traditional hanging frames, including, for example, the following:

1. heavy in weight;

2. invasive to wall integrity;

3. materials used are not always photo safe;

4. bulky and occupy larger amounts of space;

5. rigid structure;

6. not easily transported;

7. limited photo capacity; and

The subject photo wall hanging unit is capable of holding several photos. The photo pockets of the subject photo display unit are preferably two sided, thus making them reversible. The subject photo display unit possesses several desirous characteristics:

1. light weight.

2. less invasive to wall integrity.

3. photo safe, as it is preferably constructed of transparent, soft and flexible polypropylene, or other flexible plastics and equivalents.

4. it is a space saver since it can be affixed to preexisting mounts and unique places, due to its composition and design.

5. its composition and structure allow it to become collapsible and thus easily transported. It is a safe haven for photos, wherever the user is.

6. The subject photo unit has apattern to its fold which facilitates the fold up process. This pattern allows the photo unit to become a smaller compact product.

7. The subject photo unit holds a larger number of photos than conventional photo containers.

One of the main objects of the subject invention is to provide a convenient, compact photo safe unit that will hold multiple photos and will be easily transported and readily available to display “visible photo keepsakes.”

### DESCRIPTION OF THE DRAWINGS

FIG. 1 depicts one embodiment of the subject photo display unit, as viewed on a flat plane. it shows the photo slots, the openings for the entry and exit of the pictures, the transparent material of which it is comprised, and the basic design of the unit.

FIG. 2 is a smaller version of FIG. 1 but without the openings to the different slots shown.

FIG. 3 depicts the beginning of the collapsing and folding up of this photo containing unit, as we view the right hand column being placed atop the center column.

FIG. 4 depicts the continuance of the collapsing of this product, as we view the left hand column being placed atop the right hand column and center column.

FIG. 5 illustrates the beginning of the folding up process as the bottom is lifted up.

FIG. 6 illustrates the completion of the collapsing, folding up and therefore compacting of this embodiment.

### DESCRIPTION OF THE PREFERRED EMBODIMENTS

This invention pertains to a foldable transparent, light weight, multiple photo containing unit. It has hard structural frame form. One of its unique features is its structured pattern.

This pattern enables it to fold up into an easily transported compact unit. Preferably, the subject photo display unit folds up into the size of the largest pocket superposed thereon, which is preferably located on the top row, center column.

In view of the teachings herein, those skilled in the art will appreciate that the subject photo display unit can be manufactured according to conventional methods routinely used in the art. For example, when using polymers such as polypropylene, pockets can be superposed on to a base translucent material by a heat sealing process. Two pieces of transparent polypropylene material are sealed together at the borders of the picture slots. One side of each slot is left open for photo entry and exit.

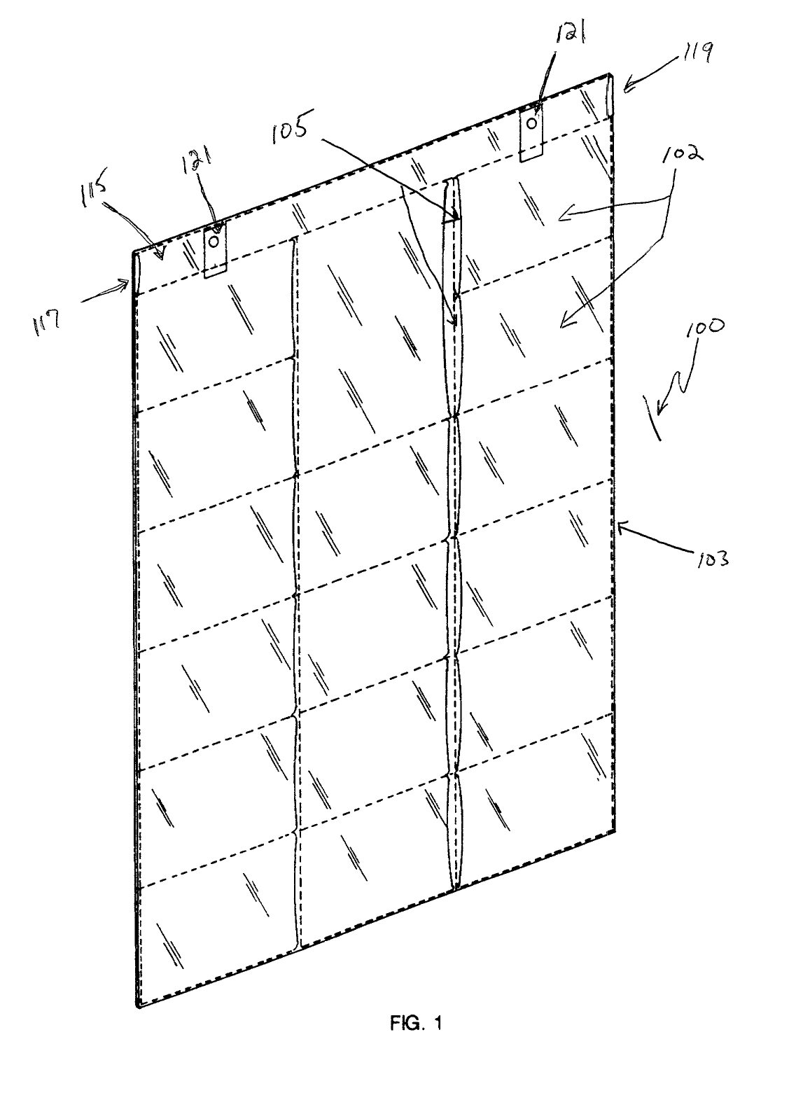

Turning now to the drawings, FIG. 1 depicts one embodiment 100 of the subject foldable display unit, as viewed on a flat plane. It shows the pockets 102 superposed on a base 103, the openings 105 for the entry and exit of the photos or other display articles, the transparent material of which it is comprised, and the basic design of the unit.

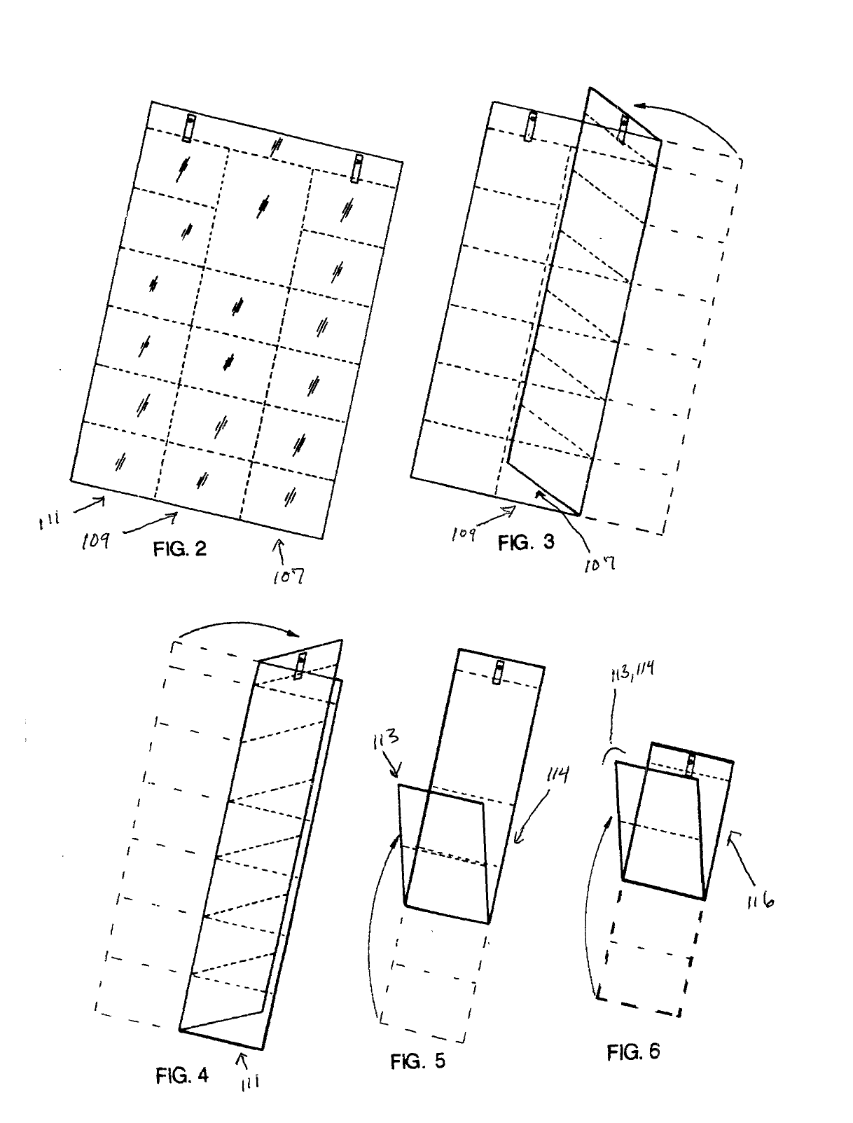

FIG. 2 is a smaller version of FIG. 1 but without the openings to the different slots shown.

FIG. 3 depicts the beginning of the collapsing and folding up of the embodiment shown in FIG. 1, whereby the right hand column 107 being placed atop the center column 109. Those skilled in the art will appreciate that the amount of columns could be adjusted depending on the desired size and capacity of the display unit. Preferably, the amount is an odd number such that there is a single center column.

FIG. 4 depicts the continuance of the collapsing of this product, as we view the left hand column 111 being placed atop the right hand 107 column and center column 109.

FIG. 5 illustrates the beginning of the folding up process as the bottom portion 113 of the folded columns is lifted up and placed over the center portion 114 of the folded columns.

FIG. 6 illustrates the completion of the collapsing, folding up and therefore compacting of this embodiment 100 of the subject foldable display unit, whereby the folded bottom and center portions, 113,114, is folded over the top portion 116 of the folded columns.

Shown in FIGS. 1-6, at the top of the unit there is a slot 115 that preferably measures one and a half inches in depth. This slot runs across the entire width of the unit and is open at both ends 117, 119. Beginning at the lower edge of this slot are the three vertical columns 111, 109, 107 of photo slots.

In the configuration of pockets, columns, and rows of embodiment 100, the top pocket 117 of the second column 109 determines the size to which the unit folds down and is compacted. Those skilled in the art will appreciate, in view of the teachings herein, that there are a number of sequences for folding up the display unit. However, the inventor has found that folding up the display unit onto itself to the size of a pocket in the center unit facilitates a more compact, folded unit.

Two tabs 121 that facilitate hanging of this embodiment are located on the back side of the unit, each placed toward the sides of the open ended slot that runs across the width of the unit. The placement of the tabs promotes stability in the display of the unit. Alternatively, magnets can be attached to the photo display unit to facilitate display on metallic surfaces.

The following features of this invention are improvements from other photo units:

1. It is photo safe.

2. It holds standard sized photos, such as 3×5″ and 4×6″ etc. Many framed photo containers contain smaller and irregular sized photos.

3. Other photo units can not be compacted and easily transported like this unit.

4. This unit is light weight, unlike traditional wall hanging containers.

5. The structure and light weight promote the unique compacting and convenient transport of the subject invention.

6. The open ended slot that runs across the top of the unit allows it to be indexed when displayed and/or folded up and stored.

7. This product can be easily hung or displayed.

8. This product presents a readily available, safe, storage haven for developed film.

It should be understood that the examples and embodiments described herein are for illustrative purposes only and that various modifications or changes in light thereof will be suggested to persons skilled in the art and are to be included within the spirit and purview of this application and the scope of the appended claims.

What is claimed is:

1. A foldable display unit comprising:
(a) a base made of flexible materials; and wherein said base comprises at least one first crease defining at least one column on said base and at least one second crease transverse to said at least one first crease defining at least one row on said base; and
(b) two or more pockets superposed on said base for holding a display article, wherein two or more pockets are arranged on said base to define at least one column and to define at least two rows;
wherein said at least one column and at least two rows are configured on said base such that said base may be folded down to a size corresponding to said at least one larger pocket.

2. The display unit of claim 1 wherein said base and said two or more pockets are made of a translucent material.

3. The display unit of claim 2, wherein said translucent material is polypropylene.

4. The display unit of claim 1, wherein said display article is selected from the group consisting of photograph, postcard, card, and letter.

5. The display unit of claim 1, wherein said base has 3, 5, 7, 9, or 11 columns configured thereon, and wherein said larger of said two or more pockets is positioned on a center column.

6. The display unit of claim 5, wherein said larger of said two or more pockets is positioned on the top of said center column.

7. The foldable display unit of claim 1 comprising a right column, a center column, and a left column and six rows, wherein said right, center and left columns comprise a top one-third portion, a center one-third portion, and a bottom one-third portion.

8. The foldable display unit of claim 7, wherein said middle one-third and bottom one-third portions comprise pockets sized to hold display articles having a dimension of 3×5 inches; and wherein said top one-third portion of said center column comprises a pocket sized to hold a display article having a dimension of 4×6 inches.

9. The foldable display unit of claim 8, wherein said foldable display unit is folded by folding said right column and left column over said center column, whereby said right column, left column and center column form a single column comprising a top one-third section, a center one-third section and a bottom one-third section.

10. The foldable display unit of claim 9, wherein said bottom one-third section is folded over said middle one-third section to form an intermediary bottom section.

11. The foldable display unit of claim 10, wherein said intermediary bottom section is folded over said top one-third section.

12. The foldable display unit of claim 1, further comprising at least two tabs rigidly attached to said base to facilitate hanging said foldable display unit.

13. The foldable display unit of claim 1, wherein said two or more pockets comprise at least one larger pocket that is larger than other of said two or more pockets.
